(19) United States
(12) Patent Application Publication
(10) Pub. No.: US 2014/0092627 A1
(43) Pub. Date: Apr. 3, 2014

(54) OPTICAL WAVEGUIDE SHEET, EDGE-LIT BACKLIGHT UNIT AND LAPTOP COMPUTER

(71) Applicant: KEIWA INC., Osaka (JP)

(72) Inventors: Hironori NAKASHIMA, Osaka (JP); Akira FURUTA, Osaka (JP)

(73) Assignee: KEIWA INC., Osaka (JP)

(21) Appl. No.: 14/039,458

(22) Filed: Sep. 27, 2013

(30) Foreign Application Priority Data
Sep. 28, 2012 (JP) 2012-218698

(51) Int. Cl. F21V 8/00

(52) U.S. Cl. CPC G02B 6/0055
USPC 362/606; 385/131

(57) ABSTRACT

The optical waveguide sheet of the present invention is for use in an edge-lit backlight unit of a liquid crystal display unit of laptop computers having a housing thickness of no greater than 21 mm, and includes: an optical waveguide layer containing a polycarbonate-based resin as a principal component; and a hard coat layer laminated on the back face side of the optical waveguide layer, an average thickness of the optical waveguide sheet being no greater than 600 μm. An average thickness of the hard coat layer is preferably from 2 μm to 20 μm. The optical waveguide sheet preferably further includes a lower refractive index layer that is laminated on the back face of the optical waveguide layer and has a refractive index lower than that of the optical waveguide layer, and the hard coat layer is preferably laminated on the back face of the lower refractive index layer.

### BACKGROUND OF THE INVENTION

1. Field of the Invention

The present invention relates to an optical waveguide sheet, an edge-lit backlight unit and a laptop computer.

2. Discussion of the Background

Liquid crystal display devices in widespread use have been in a backlight system where light emission is executed by irradiating onto a liquid crystal layer from the rear face. In this system, a backlight unit such as an edge-lit backlight unit or a direct-lit backlight unit is mounted on the underside of the liquid crystal layer. As shown in FIG. 5, such an edge-lit backlight unit 110 generally includes a top plate 116 disposed on the backmost face of a liquid crystal display unit, a reflection sheet 115 disposed on the front face of the top plate 116, an optical waveguide sheet 111 disposed on the front face of the reflection sheet 115, and a light source 117 that emits rays of light toward the end face of the optical waveguide sheet 111 (see Japanese Unexamined Patent Application, Publication No. 2010-177130). In the edge-lit backlight unit 110 shown in FIG. 5, rays of light that are emitted by the light source 117 and enter the optical waveguide sheet 111 propagate in the optical waveguide sheet 111. A part of the propagating rays of light exit from the back face of the optical waveguide sheet 111, are reflected on the reflection sheet 115 and enter again the optical waveguide sheet 111.

In laptop computers having such a liquid crystal display unit, in order to enhance its portability and user-friendliness, a reduction in thickness and weight is required, leading to a requirement also for a reduction in thickness of the liquid crystal display unit. In particular, in a thinner type laptop computer referred to as Ultrabook (registered trademark) in which the thickness of the thickest part of its housing is no greater than 21 mm, it is desired that the thickness of the liquid crystal display unit is about 4 mm to 5 mm, and thus, further a reduction in thickness of the edge-lit backlight unit incorporated into the liquid crystal display unit has been desired.

In regard to an edge-lit backlight unit 210 of such Ultrabook, as shown in FIG. 6, an edge-lit backlight unit is also proposed in which a reduction in thickness is attempted by dispensing with the reflection sheet 115 as shown in FIG. 5. The edge-lit backlight unit 210 shown in FIG. 6 includes a metal top plate 216, an optical waveguide sheet 211 overlaid on the front face of the top plate 216, and a light source 217 that emits rays of light toward the end face of the optical waveguide sheet 211, in which the front face of the top plate 216 is finished by polishing and functions as a reflection surface 216a. In this example, the rays of light that are emitted by the light source 217 and enter the optical waveguide sheet 211 propagate in the optical waveguide sheet 211, and a part of the propagating rays of light exit from the back face of optical waveguide sheet 211, are reflected on the reflection surface 216a disposed on the front face of the top plate 216, and enter again the optical waveguide sheet 211. Thus, in the edge-lit backlight unit 210 shown in FIG. 6, the front face of the top plate 216 corresponds to the reflection surface 216a, and therefore the reflection surface 216a can serve as the reflection sheet 115 shown in FIG. 5. Therefore, the edge-lit backlight unit 210 dispenses with the reflection sheet 115, leading to achievement of a reduction in thickness of the liquid crystal display unit.

### PRIOR ART DOCUMENTS

### Patent Documents

Patent Document 1: Japanese Unexamined Patent Application, Publication No. 2010-177130

### SUMMARY OF THE INVENTION

The present inventors found that when a laptop computer having the edge-lit backlight unit 210 shown in FIG. 6 is used, a defect arises that luminance of the liquid crystal display surface is uneven (lack in uniformity of the luminance). The present inventors thoroughly investigated causes of the defect, and consequently found that the back face of the optical waveguide sheet 211 of the edge-lit backlight unit 210 grazes against the top plate 216 to produce scuffs on the back face of the optical waveguide sheet 211, and rays of light that enter the scuffs are diffused, leading to the occurrence of the lack in uniformity of the luminance.

The present invention was made in view of the foregoing circumstances, and an object of the present invention is to provide an optical waveguide sheet by which, when used in an edge-lit backlight unit of a liquid crystal display device, the reduction in thickness is achieved while suppressing the lack in uniformity of the luminance of a liquid crystal display surface. Furthermore, another object of the present invention is to provide an edge-lit backlight unit and a laptop computer in which the lack in uniformity of the luminance is suppressed and the reduction in thickness is achieved.

According to an aspect of the present invention made for solving the aforementioned problems, an optical waveguide sheet is for use in an edge-lit backlight unit of a liquid crystal display unit in a laptop computer having a housing thickness of no greater than 21 mm, the optical waveguide sheet including:

an optical waveguide layer containing a polycarbonate-based resin as a principal component; and

a hard coat layer laminated on the back face side of the optical waveguide layer,

an average thickness of the optical waveguide sheet being no greater than 600 μm.

Since the optical waveguide sheet has the hard coat layer on the back face side of the optical waveguide layer containing a polycarbonate-based resin as a principal component, the scuff of the optical waveguide layer can be prevented by the hard coat layer even when the optical waveguide sheet is overlaid on, for example, the front face of a metal top plate and the optical waveguide sheet grazes against the overlaid surface of the top plate or the like. Thus, lack in uniformity of luminance caused by the scuff of the optical waveguide layer can be reliably prevented. Furthermore, since the average thickness of the optical waveguide sheet is no greater than 600 μm, a reduction in thickness of backlight units employing the optical waveguide sheet is achieved.

In the optical waveguide sheet, an average thickness of the hard coat layer is preferably no less than 2 μm and no greater than 20 μm. Thus, the reduction in thickness of the optical waveguide sheet can be achieved while reliably preventing the scuff of the optical waveguide layer.

It is preferred that the optical waveguide sheet further includes a lower refractive index layer, the lower refractive index layer being laminated on the back face of the optical waveguide layer and having a refractive index lower than that of the optical waveguide layer, and the hard coat layer is laminated on the back face of the lower refractive index layer. Thus, the rays of light that enter from the optical waveguide layer to the interface with the lower refractive index layer can be totally reflected in a suitable manner to the front face side. Therefore, the optical waveguide sheet can allow the rays of incident light from the light source to reliably propagate in the optical waveguide layer.

In the optical waveguide sheet, a ratio of the thickness of the lower refractive index layer to that of the optical waveguide layer is preferably no less than 1/50 and no greater than ⅕. Thus, the rays of incident light from the light source can be further reliably allowed to propagate in the optical waveguide layer.

In the optical waveguide sheet, a principal component of the lower refractive index layer is preferably an acrylic resin. Thus, hardness of the lower refractive index layer can be comparatively high. Therefore, in the optical waveguide sheet, when the lower refractive index layer is disposed between the optical waveguide layer and the hard coat layer, the occurrence of curling of the optical waveguide sheet due to the difference in hardness between the optical waveguide layer and the hard coat layer can be prevented. In addition, according to the optical waveguide sheet, the hardness of the back face side can be further optimized by increasing the hardness of the lower refractive index layer.

In the optical waveguide sheet, a relative refractive index of the lower refractive index layer with respect to the optical waveguide layer is preferably no greater than 0.95. When the relative refractive index is no greater than 0.95, a critical angle of total reflection can be no less than 71.8 degree in accordance with Snell's law. Thus, among the rays of light that enter from the optical waveguide layer to the interface, rays of light having an angle of incidence of no less than 71.8 degree with respect to a normal of an interface with the lower refractive index layer are totally reflected on the interface. Thus, the optical waveguide sheet can allow the rays of incident light from the light source to further reliably propagate in the optical waveguide layer.

In the optical waveguide sheet, the lower refractive index layer preferably has light scattering portions colored through laser irradiation. Thus, a part of the rays of light that propagate in the optical waveguide layer exit from the back face of the optical waveguide layer into the lower refractive index layer, and a part of the rays of light that exit from the back face of the optical waveguide layer enter the light scattering portions, leading to scattering of the rays of light. Furthermore, a part of the scattered rays of light enter again into the optical waveguide layer, and exit from the front face of the optical waveguide sheet. Thus, suitable rays of light are enabled to exit from the entire front face of the optical waveguide sheet by providing the light scattering portions at desired positions in the lower refractive index layer using laser irradiation.

According to the optical waveguide sheet, the optical waveguide layer and the lower refractive index layer are preferably formed through a coextrusion molding process. Thus, the optical waveguide sheet having an average thickness within the aforementioned range can be easily and surely formed.

In the optical waveguide sheet, pencil hardness of the back face side thereof is preferably at least HB. Thus, scuff resistance can be improved, and the lack in uniformity of luminance of the liquid crystal display surface can be further suppressed.

In addition, the edge-lit backlight unit according to another aspect of the present invention includes: a top plate disposed on the backmost face of a liquid crystal display unit, with a front face of the top plate being formed to have a reflection surface; the optical waveguide sheet having the configuration described above, the optical waveguide sheet being overlaid on the front face of the top plate; and a light source that emits rays of light toward the end face of the optical waveguide sheet.

Since the edge-lit backlight unit according to the aspect of the present invention has the optical waveguide sheet overlaid on the front face of the top plate, rays of light that exit from the back face side of the hard coat layer of the optical waveguide sheet are reflected on the reflection surface on the front face of the top plate and enter again the optical waveguide sheet. Thus, the edge-lit backlight unit does not employ a conventional reflection sheet, and therefore the reduction in thickness is achieved. In addition, according to the edge-lit backlight unit, due to the optical waveguide sheet being overlaid on the front face of the top plate, the hard coat layer of the optical waveguide sheet abuts the front face of the top plate. Therefore, the edge-lit backlight unit is unlikely to be scuffed, as described above, and accordingly the lack in uniformity of luminance can be reliably prevented.

According to the edge-lit backlight unit of the aspect of the present invention, it is preferred that the top plate is made of metal, and an arithmetic average roughness (Ra) of the reflection surface is no greater than 0.2 μm. The edge-lit backlight unit has a metal top plate, and therefore the reflection surface can be easily and surely formed by polishing the surface thereof. Furthermore, when the arithmetic average roughness of the reflection surface is no greater than 0.2 μm, rays of light that exit from the back face of the optical waveguide sheet are likely to be specularly reflected on the reflection surface, leading to a high utilization efficiency of the rays of light, and furthermore the surface of the reflection surface becomes even, enabling the scuff of the back face of the optical waveguide sheet abutting the reflection surface to be minimized.

Furthermore, the edge-lit backlight unit according to another aspect of the present invention may include: a top plate disposed on the backmost face of a liquid crystal display unit; a reflection sheet overlaid on the front face of the top plate; the optical waveguide sheet having the configuration described above, the optical waveguide sheet being overlaid on the front face of the reflection sheet; and a light source that emits rays of light toward the end face of the optical waveguide sheet. Due to the edge-lit backlight unit having the aforementioned configuration, the edge-lit backlight unit can further prevent the lack in uniformity of luminance while achieving the reduction in thickness.

Furthermore, the laptop computer according to another aspect of the present invention includes the edge-lit backlight unit having the configuration described above in a liquid crystal display unit.

Since the laptop computer includes the edge-lit backlight unit having the configuration described above, the laptop computer has the advantages described above. When the front face of the top plate in the laptop computer functions as a reflection surface, the laptop computer does not require a conventional reflection sheet, leading to achievement of the reduction in thickness. In addition, due to the hard coat layer of the optical waveguide sheet abutting the front face of the top plate, the optical waveguide sheet is unlikely to be scuffed, and therefore the lack in uniformity of luminance can be reliably prevented.

It is to be noted that the term “housing” as referred to means a casing that totally houses constructional elements of the laptop computer, and the term “top plate” as referred to means a platy member that is a part of the housing and disposed on the backmost face of a liquid crystal display unit of the laptop computer. The term “back face of an optical waveguide layer” as referred to means a surface on a top plate side of the optical waveguide layer, i.e., a surface on the other side of a display surface of the liquid crystal display unit. In addition, the term “front face” as referred to means a surface on the other side of the aforementioned back face, i.e., a surface on the side of the display surface of the liquid crystal display unit. The term “average thickness” as referred to means an average of values determined in accordance with A-2 method prescribed in JIS-K-7130, section 5.1.2. The term “relative refractive index of a lower refractive index layer with respect to an optical waveguide layer” as referred to means a value obtained by dividing an absolute refractive index of the lower refractive index layer by the absolute refractive index of the optical waveguide layer. It is to be noted that when the term “refractive index” is simply used herein, the term is used as meaning the absolute refractive index. The refractive index is measured using a light having a wavelength of 589.3 nm (sodium D line). The arithmetic average roughness (Ra) is a value obtained in accordance with JIS B0601-1994 under conditions involving a cut-off λc of 2.5 mm and an evaluation length of 12.5 mm. The term “pencil hardness” as referred to means a value of pencil scratch hardness defined in section 8.4 in the test method prescribed in JIS K5400.

### Effects of the Invention

As explained in the foregoing, when the optical waveguide sheet according to the aspect of the present invention is used in an edge-lit backlight unit of a liquid crystal display device, a reduction in thickness of the edge-lit backlight unit is achieved while lack in uniformity of luminance of a liquid crystal display surface is suppressed. In addition, according to the edge-lit backlight unit and the laptop computer according to the aspects of the present invention, the lack in uniformity of luminance is suppressed and the reduction in thickness is achieved.

### BRIEF DESCRIPTION OF THE DRAWINGS

FIG. 1 is a schematic perspective view of a laptop computer according to an embodiment of the present invention illustrating: (A) a state in which a liquid crystal display unit is lifted; and (B) a state in which the liquid crystal display unit is closed;

FIG. 2 is a schematic cross sectional view illustrating an edge-lit backlight unit of the laptop computer shown in FIG. 1;

FIG. 3 is a schematic cross sectional view illustrating an optical waveguide sheet of the edge-lit backlight unit shown in FIG. 2;

FIG. 4 is a schematic cross sectional view illustrating an optical waveguide sheet according to an embodiment that is different from the optical waveguide sheet shown in FIG. 3;

FIG. 5 is a schematic cross sectional view illustrating a conventional edge-lit backlight unit; and

FIG. 6 is a schematic cross sectional view illustrating a conventional edge-lit backlight unit having a configuration unit other than that shown in FIG. 5.

### DESCRIPTION OF EMBODIMENTS

Hereinafter, preferred modes for carrying out the invention will be explained in more detail with references to the drawings, if necessary.

### First Embodiment

### Laptop Computer 1

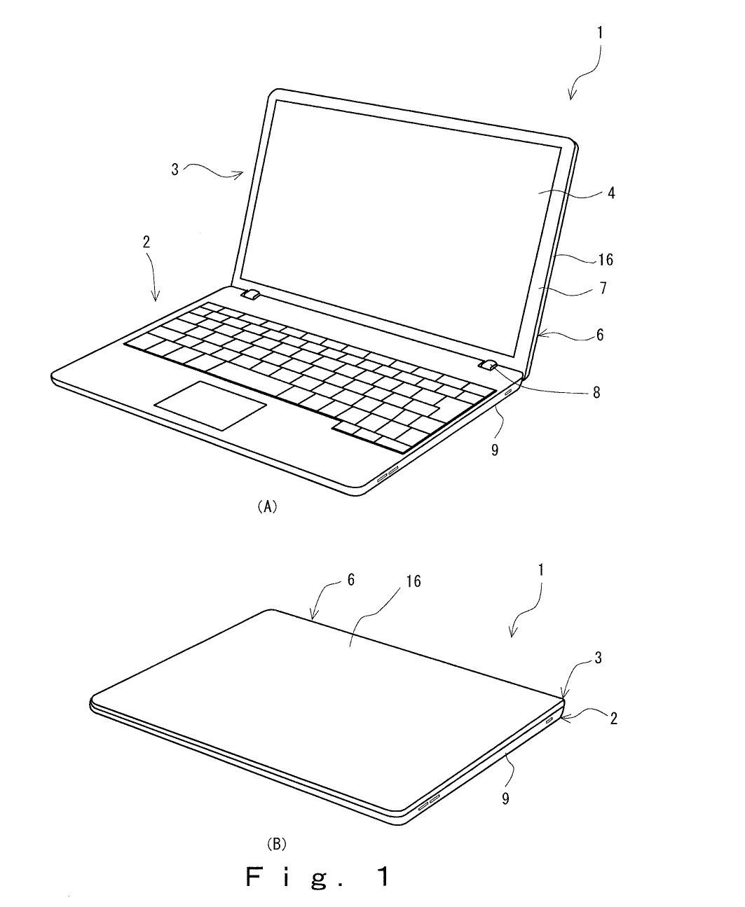

A laptop computer 1 shown in FIG. 1 includes an operation unit 2, and a liquid crystal display unit 3 rotatably (enabling to be opened/closed) attached to the operation unit 2. The laptop computer 1 has a housing thickness (at the thickest part (when the liquid crystal display unit 3 is closed)) of no greater than 21 mm, and is generally referred to as Ultrabook (registered trademark) (hereinafter, may be also referred to as “ultraslim computer 1”).

The liquid crystal display unit 3 of the ultraslim computer 1 includes a liquid crystal panel 4, and an edge-lit backlight unit 11 (hereinafter, may be also referred to as “backlight unit 11”) that directs rays of light from the back face side toward the liquid crystal panel 4. The liquid crystal panel 4 is held at the back face, the lateral face and a circumference of the front face by a casing for a liquid crystal display unit 6 of the housing. In this embodiment, the casing for a liquid crystal display unit 6 includes a top plate 16 disposed on the back face (i.e., the rear face) of the liquid crystal panel 4, and a front face support member 7 disposed on the front face side of the circumference of the front face of the liquid crystal panel 4. Note that the top plate 16, which is a partial member of the casing for a liquid crystal display unit 6, is provided so that its front face is formed to have a reflection surface 16a and functions as a partial member of the backlight unit 11, as described later. Note that the housing of the ultraslim computer 1 includes the casing for a liquid crystal display unit 6, and a casing for an operation unit 9 that is rotatably attached to the casing for a liquid crystal display unit 6 through a hinge part 8 and contains a central processing unit (ultra-low voltage CPU) and the like.

The thickness of the liquid crystal display unit 3 is not particularly limited as long as the housing thickness falls within a desired range, but the upper limit of the thickness of the liquid crystal display unit 3 is preferably 7 mm, more preferably 6 mm, and still more preferably 5 mm. On the other hand, the lower limit of the thickness of the liquid crystal display unit 3 is preferably 2 mm, more preferably 3 mm, and still more preferably 4 mm. When the thickness of the liquid crystal display unit 3 exceeds the above upper limit, it may be difficult to satisfy a requirement of a reduction in thickness of the ultraslim computer 1. Furthermore, when the thickness of the liquid crystal display unit 3 is less than the above lower limit, a decrease in strength and/or in luminance of the liquid crystal display unit 3 may be incurred.

### Backlight Unit 11

The backlight unit 11 includes an optical waveguide sheet 12, a top plate 16 on which the optical waveguide sheet 12 is directly overlaid, and a light source 17 that emits rays of light toward the optical waveguide sheet 12, as shown in FIG. 2. In other words, the backlight unit 11 does not include a reflection sheet conventionally disposed between the top plate 16 and the optical waveguide sheet 12.

### Optical Waveguide Sheet 12

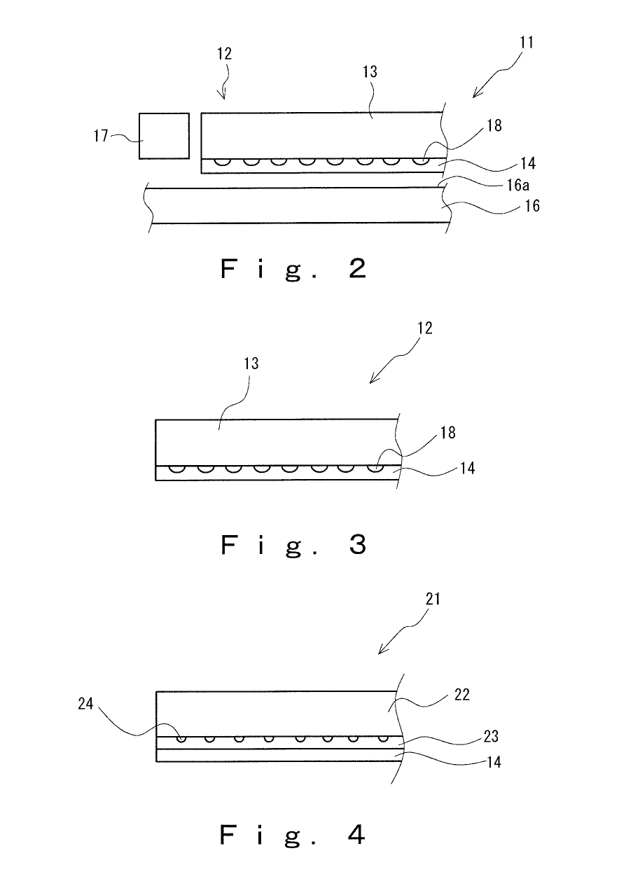

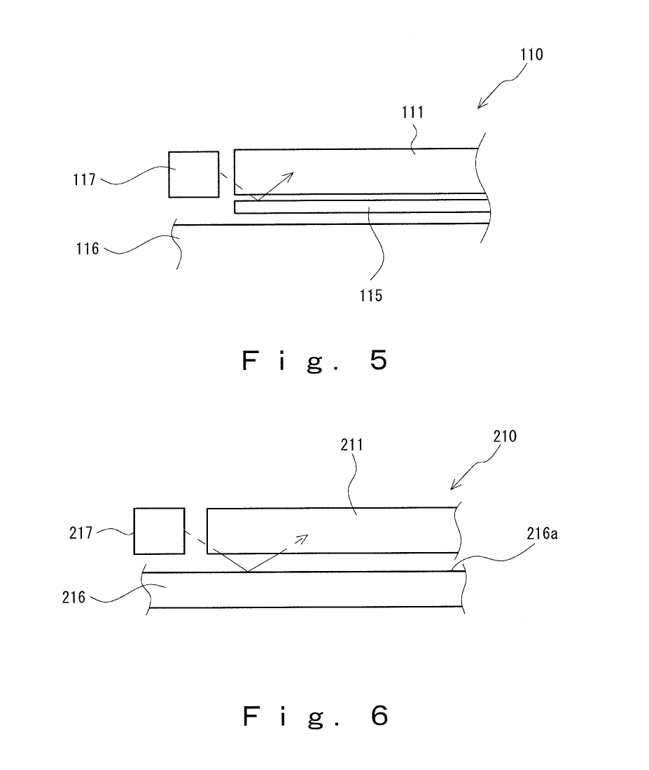

The optical waveguide sheet 12 is a sheet having a two-layer structure composed of an optical waveguide layer 13 and a hard coat layer 14, as shown in FIG. 3. The optical waveguide sheet 12 is formed into a plate (non-wedge shape) that is in a substantially square shape in a planar view, and has a substantially uniform thickness. The average thickness of the optical waveguide sheet 12 is no greater than 600 μm. The upper limit of the average thickness of the optical waveguide sheet 12 is more preferably 580 μm, and still more preferably 550 μm. On the other hand, the lower limit of the average thickness of the optical waveguide sheet 12 is preferably 250 μm, more preferably 280 μm, and still more preferably 300 μm. When the average thickness exceeds the above upper limit, it may be difficult to satisfy a requirement of a reduction in thickness of the backlight unit 11 desired in the ultraslim computer 1. In addition, when the average thickness is less than the above lower limit, the strength of the optical waveguide sheet 12 may be insufficient, and a sufficient amount of the rays of light from the light source 17 may not be directed to the optical waveguide sheet 12.

The optical waveguide layer 13 is a transparent resin layer that contains a polycarbonate-based resin as a principal component. Since the polycarbonate-based resin has a high degree of transparency, a loss of the rays of light in the optical waveguide layer 13 can be minimized. In addition, since the polycarbonate-based resin has a high refractive index, total reflection is likely to occur at the interface (the front face of the optical waveguide layer 13) between the optical waveguide layer 13 and an air layer (an air layer in a gap between the optical waveguide layer 13 and the liquid crystal panel), and at the interface between the optical waveguide layer 13 and the hard coat layer 14, allowing for efficient propagation of the rays of light. Furthermore, since the polycarbonate-based resin has heat resistance, its deterioration or the like caused by heat generation in the light source 17 is minimized.

The polycarbonate-based resin is not particularly limited, and may be any one of a linear polycarbonate-based resin and a branched polycarbonate-based resin, or may be a mixture of polycarbonate-based resins that contains both of the linear polycarbonate-based resin and the branched polycarbonate-based resin.

The polycarbonate-based resin is a linear aromatic polycarbonate-based resin produced by a well-known phosgene process or a melt process, and is composed of a carbonate unit and a diphenol unit. Examples of a precursor for introducing the carbonate unit include phosgene, diphenyl carbonate, and the like. Furthermore, examples of the diphenol include 2,2-bis(4-hydroxyphenyl)propane, 2,2-bis(3,5-dimethyl-4-hydroxyphenyl)propane, 1,1-bis(4-hydroxyphenyl)cyclohexane, 1,1-bis(3,5-dimethyl-4-hydroxyphenyl)cyclohexane, 1,1-bis(4-hydroxyphenyl)decane, 1,1-bis(4-hydroxyphenyl)propane, 1,1-bis(4-hydroxyphenyl)cyclodecane, 1,1-bis(3,5-dimethyl-4-hydroxyphenyl)cyclododecane, 4,4′-dihydroxydiphenyl ether, 4,4′-thiodiphenol, 4,4′-dihydroxy-3,3-dichlorodiphenyl ether, and the like. These may be used either alone, or in combination of two or more thereof. The linear polycarbonate-based resin is produced by a method disclosed in, for example, U.S. Pat. No. 3,989,672, and the like.

The branched polycarbonate-based resin is a polycarbonate-based resin produced using a branching agent, and examples of the branching agent include phloroglucin, trimellitic acid, 1,1,1-tris(4-hydroxyphenyl)ethane, 1,1,2-tris(4-hydroxyphenyl)ethane, 1,1,2-tris(4-hydroxyphenyl)propane, 1,1,1-tris(4-hydroxyphenyl)methane, 1,1,1-tris(4-hydroxyphenyl)propane, 1,1,1-tris(2-methyl-4-hydroxyphenyl)methane, 1,1,1-tris(2-methyl-4-hydroxyphenyl)ethane, 1,1,1-tris(3-methyl-4-hydroxyphenyl)methane, 1,1,1-tris(3-methyl-4-hydroxyphenyl)ethane, 1,1,1-tris(3,5-dimethyl-4-hydroxyphenyl)methane, 1,1,1-tris(3,5-dimethyl-4-hydroxyphenyl)ethane, 1,1,1-tris(3-chloro-4-hydroxyphenyl)methane, 1,1,1-tris(3-chloro-4-hydroxyphenyl)ethane, 1,1,1-tris(3,5-dichloro-4-hydroxyphenyl)methane, 1,1,1-tris(3,5-dichloro-4-hydroxyphenyl)ethane, 1,1,1-tris(3-bromo-4-hydroxyphenyl)methane, 1,1,1-tris(3-bromo-4-hydroxyphenyl)ethane, 1,1,1-tris(3,5-dibromo-4-hydroxyphenyl)methane, 1,1,1-tris(3,5-dibromo-4-hydroxyphenyl)ethane, 4,4′-dihydroxy-2,5-dihydroxydiphenyl ether, and the like.

The branched polycarbonate-based resin can be produced, for example, by a method in which a polycarbonate oligomer derived from an aromatic diphenol, the branching agent and phosgene, an aromatic diphenol and a chain-end terminator are reacted with stirring so that the reaction mixture liquid containing the components is under turbulent flow conditions, and upon the increase in the viscosity of the reaction mixture liquid, an aqueous alkali solution is added and the reaction mixture liquid is allowed to react under laminar flow conditions, as disclosed in Japanese Unexamined Patent Application, Publication No. H03-182524.

The optical waveguide layer 13 preferably contains the branched polycarbonate-based resin in an amount within the range of no less than 5% by weight and no greater than 80% by weight, and more preferably within the range of no less than 10% by weight and no greater than 60% by weight in the polycarbonate-based resin. This is because when the amount of the branched polycarbonate-based resin is less than 5% by weight, an extensional viscosity of the resin is decreased and molding by extrusion molding is difficult, whereas the amount of the branched polycarbonate-based resin exceeding 80% by weight results in an increased shear viscosity of the resin and molding processibility of the resin is impaired.

Although the optical waveguide layer 13 may contain other optional component, the optical waveguide layer 13 preferably contains the linear polycarbonate-based resin and/or the branched polycarbonate-based resin in an amount of preferably no less than 90% by mass, and more preferably no less than 98% by mass. Examples of the optional component used in the optical waveguide layer 13 include an ultraviolet ray absorbing agent, a stabilizer, a lubricant, a processing aid, a plasticizer, an anti-impact agent, a retardation reducing agent, a delustering agent, an antimicrobial, a fungicide, and the like. However, since the optical waveguide layer 13 must allow for the propagation of the rays of light, the optical waveguide layer 13 is preferably formed transparent, and particularly preferably formed colorless and transparent.

The average thickness of the optical waveguide layer 13 is not particularly limited, but is preferably no greater than 595 μm. The upper limit of the average thickness of the optical waveguide layer 13 is more preferably 570 μm, and still more preferably 550 μm. Furthermore, the lower limit of the average thickness of the optical waveguide layer 13 is preferably 200 μm, more preferably 230 μm, and still more preferably 250 μm. When the average thickness exceeds the above upper limit, the optical waveguide sheet 12 is so thick that it may be difficult to satisfy a requirement of a reduction in thickness of the backlight unit 11 desired in the ultraslim computer 1. On the other hand, when the average thickness is less than the above lower limit, the optical waveguide sheet 12 is so thin that its strength may be insufficient, and a sufficient amount of the rays of light from the light source 17 may not be directed to the optical waveguide layer 13.

In addition, the refractive index of the optical waveguide layer 13 is preferably no less than 1.57 and no greater than 1.68, and more preferably no less than 1.59 and no greater than 1.66.

A plurality of diffusion dots 18 are provided on the back face of the optical waveguide layer 13. The plurality of diffusion dots 18 are typically white dots. The plurality of diffusion dots 18 are provided in a pattern designed such that planar outgoing rays of light substantially uniformly exit.

The hard coat layer 14 is laminated on the back face of the optical waveguide layer 13. The hard coat layer 14 contains a synthetic resin such as a thermosetting resin and/or an active energy ray-curable resin as a principal component. Among these, the hard coat layer 14 preferably contains an active energy ray-curable resin that is cured by an active energy ray such as an ultraviolet ray and an electron beam. In particular, the principal component of the hard coat layer 14 is preferably an active energy ray-curable acrylic resin, in light of decreasing the refractive index of the hard coat 14.

Examples of the active energy ray-curable acrylic resin include a composition prepared by mixing a monomer or oligomer having a polymerizable functional group such as a (meth)acryloyl group and a (meth)acryloyloxy group. The composition is preferably prepared using a polyfunctional monomer having a functionality of no less than three. Note that the monomer or oligomer may be used either alone, or as a mixture of two or more thereof.

The monomer is not particularly limited, and examples thereof include: monofunctional acrylates such as methyl (meth)acrylate, lauryl (meth)acrylate, ethoxy diethylene glycol (meth)acrylate, methoxy triethylene glycol (meth)acrylate, phenoxyethyl (meth)acrylate, tetrahydrofurfuryl (meth)acrylate, isobornyl (meth)acrylate, 2-hydroxyethyl (meth)acrylate, 2-hydroxypropyl (meth)acrylate, 2-hydroxy-3-phenoxy (meth)acrylate; polyfunctional acrylates such as neopentyl glycol di(meth)acrylate, 1,6-hexanediol di(meth)acrylate, trimethylolpropane tri(meth)acrylate, pentaerythritol tri(meth)acrylate, pentaerythritol tetra(meth)acrylate, dipentaerythritol tri(meth)acrylate, dipentaerythritol tetra(meth)acrylate, dipentaerythritol penta(meth)acrylate, dipentaerythritol hexa(meth)acrylate, tripentaerythritol tri(meth)acrylate, tripentaerythritol hexa(meth)acrylate, trimethylolpropane (meth)acrylic acid benzoic acid ester, and trimethylolpropane benzoic acid ester; urethane acrylates such as glycerin di(meth)acrylate hexamethylene diisocyanate, pentaerythritol tri(meth)acrylate, hexamethylene diisocyanate; and the like.

The oligomer is not particularly limited, and examples thereof include polyester (meth)acrylates, polyurethane (meth)acrylates, epoxy (meth)acrylates, polyether (meth)acrylates, alkyd (meth)acrylates, melamine (meth)acrylates, silicone (meth)acrylates, and the like.

The content of the active energy ray-curable acrylic resin is not particularly limited, and is preferably no less than 50% by mass, more preferably no less than 55% by mass, still more preferably no less than 60% by mass, and particularly preferably no less than 70% by mass with respect to the total solid content of the hard coat layer 14.

In order to initiate the polymerization of the monomer or oligomer, a photoinitiator is preferably used. The photoinitiator is not particularly limited, and examples thereof include: carbonyl compounds such as acetophenone, 2,2-diethoxyacetophenone, p-dimethylacetophenone, p-dimethylaminopropiophenone, benzophenone, benzil, 2-chlorobenzophenone, 4,4′-dichlorobenzophenone, 4,4′-bisdiethylaminobenzophenone, Michler ketone, benzyl, benzoin, benzoin methyl ether, benzoin ethyl ether, benzoin isopropyl ether, methyl benzoylformate, p-isopropyl-α-hydroxyisobutylphenone, α-hydroxyisobutylphenone, 2,2-dimethoxy-2-phenylacetophenone, and 1-hydroxycyclohexyl phenyl ketone; sulfur compounds such as tetramethylthiram monosulfide, tetramethylthiram disulfide, thioxanthone, 2-chlorothioxanthone, 2-methylthioxanthone; and the like. These photoinitiator may be used either alone, or in combination of two or more thereof.

The content of the photoinitiator is not particularly limited, but is preferably no less than 0.1% by mass and no greater than 10% by mass, and more preferably no less than 0.5% by mass and no greater than 8% by mass with respect to the total solid content of hard coat layer 14.

In order to adjust a refractive index of the hard coat layer 14 or improve heat resistance, dimension accuracy or the like of the hard coat layer 14, the hard coat layer 14 may contain inorganic ultrafine particles such as colloidal silica, colloidal aluminum oxide, colloidal calcium carbonate, smectite, mica, titanium oxide, zirconium oxide, antimony oxide, zinc oxide, magnesium oxide, talc, alumina, barium sulfate, asbestos, tin oxide-doped indium oxide (ITO), and antimony-doped tin oxide (ATO) in a dispersion state.

Furthermore, the hard coat layer 14 may contain a pigment for the purpose of improving its masking properties. Examples of the pigment contained in the hard coat layer 14 include: inorganic pigments such as carbon black, iron black, white titanium oxide, antimony white, chrome yellow, titan yellow, red iron oxide, cadmium red, ultramarine, and cobalt blue; organic pigments such as quinacridone red, isoindolinone yellow, phthalocyanine blue; metal pigments composed of flaky foils such as aluminum and brass; pearlescent (pearl-like) pigments composed of flaky foils such as titanium dioxide-coated mica and basic lead carbonate; and the like. Among these, white titanium oxide is preferred for improving the masking properties.

The content of the pigment is not particularly limited, but is preferably no less than 20% by mass and no greater than 50% by mass with respect to the total solid content of the hard coat layer 14. The upper limit of the content of the pigment is more preferably 45% by mass, and still more preferably 40% by mass. In addition, the lower limit of the content of the pigment is more preferably 25% by mass, and still more preferably 30% by mass. When the content of the pigment exceeds the above upper limit, adhesiveness of the hard coat layer 14 to the optical waveguide layer 13 may be decreased. To the contrary, when the content of the pigment is less than the above lower limit, sufficient masking properties may not be attained.

Furthermore, the hard coat layer 14 may contain an antioxidant, an ultraviolet ray absorbing agent, a levelling agent, an antistatic agent, a lubricant, a colorant, and the like.

The average thickness of the hard coat layer 14 is not particularly limited, but is preferably no less than 2 μm and no greater than 20 μm. The upper limit of the average thickness of the hard coat layer 14 is more preferably 18 μm, and still more preferably 15 μm. In addition, the lower limit of the average thickness of the hard coat layer 14 is more preferably 7 μm, and still more preferably 10 μm. When the average thickness of the hard coat layer 14 exceeds the above upper limit, it may be difficult to satisfy a requirement of a reduction in thickness of the optical waveguide sheet 12, as well as curling of the optical waveguide sheet 12 may occur due to the difference in hardness between the optical waveguide layer 13 and the hard coat layer 14. To the contrary, when the average thickness of the hard coat layer 14 is less than the above lower limit, the scuff of the optical waveguide layer 13 may not be reliably prevented.

The refractive index of the hard coat layer 14 is not particularly limited, but is preferably lower than that of the optical waveguide layer 13. The relative refractive index of the hard coat layer 14 with respect to the optical waveguide layer 13 is not particularly limited, but is preferably no greater than 0.95, more preferably no greater than 0.90, and particularly preferably no greater than 0.85. When the relative refractive index of the hard coat layer 14 with respect to the optical waveguide layer 13 is no greater than the above upper limit, a critical angle of total reflection is no greater than a certain angle (no greater than 71.8 degree) in accordance with Snell's law. Thus, among the rays of light that enter from the optical waveguide layer 13 to the interface with the hard coat layer 14, the rays of light having an angle of incidence of no less than the critical angle are totally reflected on the interface between the optical waveguide layer 13 and the hard coat layer 14. On the other hand, a part of rays of light having an angle of incidence of less than the critical angle are reflected on the optical waveguide layer 13, whereas the other part thereof enters the hard coat layer 14.

The pencil hardness of the hard coat layer 14 is preferably at least H, more preferably at least 2H, and still more preferably at least 3H. When the pencil hardness of the hard coat layer 14 falls within the above range, hardness of the back face side of the optical waveguide sheet 12 is favorably improved, and thus the scuff of the optical waveguide layer 13 can be reliably prevented. In addition, the pencil hardness of the back face side of the optical waveguide sheet 12 is preferably at least HB, more preferably at least H, and still more preferably at least 2H. When the pencil hardness of the back face side of the optical waveguide sheet 12 is below the above lower limit, the scuff of the optical waveguide layer 13 is highly unlikely to be reliably prevented.

### Top Plate 16

The top plate 16 is formed of a metal plate, and specifically, an aluminum plate. In this embodiment, the thickness of the plate is preferably no less than 500 μm and no greater than 1,200 μm, and more preferably no less than 700 μm and no greater than 900 μm. In addition, the top plate 16 is formed so that the circumference of the plate is curved toward the front face side, and this curved portion functions as a rib, whereby the top plate 16 has a sufficient strength. It is to be noted that although a portion (central portion) other than the curved portion as the rib has a flat face, the central portion may be embossed with a pattern such as a geometrical pattern.

A reflection surface 16a, which reflects rays of light, is provided on the front face (a surface on the side of the liquid crystal panel 4) of the top plate 16. Thus, the rays of light that exit from the back face of the optical waveguide sheet 12 are reflected on the reflection surface 16a toward the front face side.

Although the reflection surface 16a is formed by polishing the front face of (material plate of) the top plate 16, this forming method is not particularly limited, and a method other than the polishing can be employed.

The arithmetic average roughness (Ra) of the reflection surface 16a (the front face of the material plate of the top plate 16) is not particularly limited, but is preferably no greater than 0.2 μm, more preferably no greater than 0.1 μm, and still more preferably no greater than 0.05 μm. When the arithmetic average roughness (Ra) of the reflection surface 16a exceeds the above upper limit, rays of light that enter the reflection surface 16a may be unlikely to be specularly reflected, whereby a utilization efficiency of the rays of light may be decreased, and the back face of the optical waveguide sheet 12 may be likely to be scuffed.

### Light Source 17

The light source 17 is contained in the casing for a liquid crystal display unit 6, and disposed so that an emission surface faces to (or abuts) the end face of the optical waveguide layer 13 of the optical waveguide sheet 12. Various types of light sources can be used as the light source 17, and for example, a light emitting diode (LED) can be used as the light source 17. Specifically, a light source in which a plurality of light emitting diodes are disposed along the end face of the optical waveguide layer 13 may be used as the light source 17.

In the backlight unit 11, the following systems may be employed such as: a unilateral edge light system in which the light source 17 is disposed along only one side edge of the optical waveguide sheet 12; a bilateral edge light system in which the light source 17 is disposed along each of the opposite side edges of the optical waveguide sheet 12; an entire circumference edge light system in which the light source 17 is disposed along each side edge of the optical waveguide sheet 12; and the like.

### Production Method of Optical Waveguide Sheet 12

Next, a production method of the optical waveguide sheet 12 will be explained. However, the production method of the optical waveguide sheet 12 according to the embodiment of the present invention is not limited to the production method described below.

For example, a production method of the optical waveguide sheet 12 includes: a first step of preparing each forming material of the optical waveguide layer 13 and the hard coat layer 14; a second step of molding the optical waveguide layer 13 by extrusion molding; a third step of providing a plurality of diffusion dots 18 on the back face of the optical waveguide layer 13; and a fourth step of coating a forming material of the hard coat layer 14 on the back face of the optical waveguide layer 13 having the plurality of diffusion dots 18 provided thereon, drying the forming material of the hard coat layer 14, and irradiating the same with an active energy ray to form the hard coat layer 14.

Examples of a method for providing the plurality of diffusion dots 18 include well-known printing methods such as screen printing and ink jet printing.

Examples of a method of coating the forming material of the hard coat layer 14 include various methods such as a spin coating method, a spray coating method, a slide coating method, a dipping method, a bar-coating method, a roll coater method, and a screen printing method. Furthermore, in the production of the hard coat layer 14, a surface modification treatment such as a plasma treatment in an atmosphere of an inert gas such an argon gas or a nitrogen gas may be carried out as a pretreatment, as needed.

### Advantages

According to the backlight unit 11 of the ultraslim computer 1, rays of light from the light source 17 are emitted toward the liquid crystal panel 4 as follows. First, the rays of light from the light source 17 enter the optical waveguide layer 13 of the optical waveguide sheet 12, and the rays of light propagate in the optical waveguide layer 13. Then, among the rays of light that propagate in the optical waveguide layer 13, a part of the rays of light that reach an interface between the optical waveguide layer 13 and the hard coat layer 14 enter the hard coat layer 14, and the other part thereof is reflected to the optical waveguide layer 13. Furthermore, a part of the rays of light that enter the hard coat layer 14 exit from the back face of the hard coat layer 14. The rays of light that exit from the back face of the hard coat layer 14 are reflected on the front face (reflection surface 16a) of the top plate 16, and enter again the optical waveguide sheet 12 and thereafter exit from the front face of the optical waveguide sheet 12 toward the liquid crystal panel 4. Thus, according to the ultraslim computer 1, the reduction in thickness of the backlight unit 11 is achieved, since no reflection sheet is provided, as is different from conventional ones. Furthermore, since the optical waveguide sheet 12 is configured as a two-layer structure composed of the optical waveguide layer 13 having a thickness within a certain range and the hard coat layer 14, the reduction in thickness of the optical waveguide sheet 12 itself is also achieved.

Moreover, in the backlight unit 11 of the ultraslim computer 1, the optical waveguide sheet 12 includes the hard coat layer 14 on the back face of the optical waveguide layer 13 containing a polycarbonate-based resin as a principal component; therefore, the optical waveguide layer 13 is unlikely to be scuffed because of the abutment of the top plate 16 against the hard coat layer 14, even though the metal top plate 16 and the optical waveguide sheet 12 scuff with each other while the ultraslim computer 1 is carried. Thus, the backlight unit 11 of the ultraslim computer can reliably prevent lack in uniformity of luminance caused by the scuff of the optical waveguide layer 13. The backlight unit 11 of the ultraslim computer 1 can facilitate the reduction in thickness, because the average thickness of the optical waveguide sheet 12 falls within the above range.

### Second Embodiment

### Optical Waveguide Sheet 21

The optical waveguide sheet 21 shown in FIG. 4 is for use in an edge-lit backlight unit of a liquid crystal display unit of a laptop computer having a housing thickness of no greater than 21 mm in place of the optical waveguide sheet 12 according to the first embodiment. The optical waveguide sheet 21 is a sheet having a three-layer structure composed of an optical waveguide layer 22, a lower refractive index layer 23 laminated on the back face of the optical waveguide layer 22, and a hard coat layer 14 laminated on the back face of the lower refractive index layer 23. Since the hard coat layer 14 is identical to the hard coat layer 14 in FIG. 3, the hard coat layer according to this embodiment is designated using the same number as the hard coat layer in FIG. 3 and explanation thereof will be omitted. The optical waveguide sheet 21 is formed into plate (non-wedge shape) that is in a substantially square shape in a planar view, and has a substantially uniform thickness. The average thickness of the optical waveguide sheet 21 is no greater than 600 μm. The upper limit of the average thickness of the optical waveguide sheet 21 is more preferably 580 μm, and still more preferably 550 μm. On the other hand, the lower limit of the average thickness of the optical waveguide sheet 21 is preferably 250 μm, more preferably 280 μm, and still more preferably 300 μm. When the average thickness exceeds the above upper limit, it may be difficult to satisfy a requirement of a reduction in thickness of the backlight unit desired in the ultraslim computer. In addition, when the average thickness is less than the above lower limit, the strength of the optical waveguide sheet 21 may be insufficient, and a sufficient amount of the rays of light from the light source may not be directed to the optical waveguide sheet 21.

The average thickness of the optical waveguide layer 22 is not particularly limited, but is preferably no greater than 570 μm. The upper limit of the average thickness of the optical waveguide layer 22 is more preferably 555 μm, and still more preferably 540 μm. Furthermore, the lower limit of the average thickness of the optical waveguide layer 22 is preferably 180 μm, more preferably 200 μm, and still more preferably 220 μm. When the average thickness exceeds the above upper limit, the optical waveguide sheet 21 is so thick that it may be difficult to satisfy a requirement of a reduction in thickness of the backlight unit desired in the ultraslim computer. On the other hand, when the average thickness is less than the above lower limit, the optical waveguide sheet 21 is so thin that the strength of the optical waveguide sheet may be insufficient, and a sufficient amount of the rays of light from the light source may not be directed to the optical waveguide layer 22.

A forming material and a refractive index of the optical waveguide layer 22 are similar to those for the optical waveguide layer 13 shown in FIG. 3.

The lower refractive index layer 23 is a layer that has a lower refractive index than that of the optical waveguide layer 22. A principal component of the lower refractive index layer 23 is not particularly limited, but an acrylic resin is suitably used.

The acrylic resin is not particularly limited, and examples thereof include: poly (meth)acrylic acid esters such as polymethyl methacrylate; methyl methacrylate-(meth)acrylic acid copolymers; methyl methacrylate-(meth)acrylic acid ester copolymers; methyl methacrylate-acrylic acid ester-(meth)acrylic acid copolymers; methyl (meth)acrylate-styrene copolymers; polymers having an alicyclic hydrocarbon group (for example, methyl methacrylate-cyclohexyl methacrylate copolymers, and methyl methacrylate-norbornyl (meth)acrylate copolymers); and the like. Among these acrylic resins, poly(C1-6 alkyl (meth)acrylate)s such as polymethyl (meth)acrylate are preferred, and methyl methacrylate-based resins are more preferred.

According to the optical waveguide sheet 21, due to the principal component of the lower refractive index layer 23 being an acrylic resin, hardness of the lower refractive index layer 23 can be comparatively high. Therefore, in the optical waveguide sheet 21, occurrence of curling of the optical waveguide sheet 21 due to the difference in hardness between the optical waveguide layer 22 and the hard coat layer 14 can be favorably prevented. In addition, hardness of the back face side in the optical waveguide sheet 21 can be further enhanced by increasing the hardness of the lower refractive index layer 23. Furthermore, in the optical waveguide sheet 21, due to the principal component of the lower refractive index layer 23 being an acrylic resin, discoloration upon irradiation with a laser beam, as described later, can be suppressed.

The pencil hardness of the lower refractive index layer 23 preferably exceeds that of the optical waveguide layer 22, and is below that of the hard coat layer 14. The pencil hardness of the lower refractive index layer 23 is not particularly limited, but is preferably at least HB and at most 4H, and more preferably at least H and at most 3H. When the pencil hardness of the lower refractive index layer 23 exceeds the above upper limit, curling of the optical waveguide layer 22 due to the difference in hardness between the optical waveguide layer 22 and the lower refractive index layer 23 may occur. To the contrary, when the pencil hardness of the lower refractive index layer 23 is less than the above lower limit, hardness of the back face side of the optical waveguide sheet 21 may be unlikely to be favorably improved. On the other hand, when the pencil hardness of the lower refractive index layer 23 falls within the above range, the hardness of the back face side of the optical waveguide sheet 21 can be favorably enhanced by the lower refractive index layer 23 and the hard coat layer 14, while preventing the occurrence of the curling.

The ratio of the thickness of the lower refractive index layer 23 to that of the optical waveguide layer 22 is not particularly limited, but is preferably no less than 1/50 and no greater than ⅕. The upper limit of the ratio of the thickness of the lower refractive index layer 23 to that of the optical waveguide layer 22 is more preferably 1/10, and still more preferably 1/12. Furthermore, the lower limit of the ratio of the thickness of the lower refractive index layer 23 to that of the optical waveguide layer 22 is more preferably 1/25, and still more preferably 1/20. When the ratio of the thickness of the lower refractive index layer 23 to that of the optical waveguide layer 22 exceeds the above upper limit, the thickness of the optical waveguide layer 22 is so small that the rays of light emitted from the light source are highly unlikely to reliably propagate in the optical waveguide layer 22. To the contrary, when the ratio of the thickness of the lower refractive index layer 23 to that of the optical waveguide layer 22 is less than the above lower limit, the difference in hardness between the optical waveguide layer 22 and the hard coat layer 14 cannot be favorably compensated by the lower refractive index layer 23, and thus the curling may occur.

The refractive index of the lower refractive index layer 23 is not particularly limited, but is preferably no less than 1.47 and no greater than 1.51, and more preferably no less than 1.48 and no greater than 1.50.

The relative refractive index of the lower refractive index layer 23 with respect to the optical waveguide layer 22 is not particularly limited, but is preferably no greater than 0.95, more preferably no greater than 0.90, and particularly preferably no greater than 0.85. When the relative refractive index of the lower refractive index layer 23 with respect to the optical waveguide layer 22 is no greater than the above upper limit, a critical angle of total reflection is no greater than a certain angle (no greater than 71.8 degree) in accordance with Snell's law. Thus, among the rays of light that enter from the optical waveguide layer 22 to an interface with the lower refractive index layer 23, the rays of light having an angle of incidence no less than the above critical angle are totally reflected on the interface between the optical waveguide layer 22 and the lower refractive index layer 23. On the other hand, a part of the rays of light having an angle of incidence of less than the above critical angle are reflected to the optical waveguide layer 22, and the other part thereof enters the lower refractive index layer 23.

The lower refractive index layer 23 includes light scattering portions 24 that scatter the rays of light. The light scattering portions 24 is formed to be colored through laser irradiation. Specifically, the light scattering portions 24 are formed by incorporating a coloring agent into a forming material of the lower refractive index layer 23, providing the forming material of the lower refractive index layer 23 on the back face of the optical waveguide layer 22 to form the lower refractive index layer 23, and irradiating the formed lower refractive index layer 23 with a laser to allow the coloring agent to develop a color.

The coloring agent dispersed in the forming material of the lower refractive index layer 23 is a pigment that changes its color upon laser irradiation. Well-known organic and inorganic substances used as a laser marking agent can be used as the coloring agent. Specifically, examples thereof include: yellow iron oxide; inorganic lead compounds; manganese violet; cobalt violet; compounds of a metal such as mercury, cobalt, copper, bismuth and nickel; pearlescent pigments; silicon compounds; micas; kaolins; silica sand; diatomaceous earth, talc; and the like. These may be used either alone, or in combination of two or more thereof. However, since formation of a reflecting pattern that reflects rays of light in the optical waveguide sheet 21 is intended through laser irradiation, it is preferred for a dot shape or the like that constitutes the reflection pattern to have a color that reflects rays of light. Therefore, it is preferred to incorporate into the optical waveguide sheet 21 a coloring agent that produces a white color upon laser irradiation, whereas, to the contrary, coloring agents that are carbonized upon the laser irradiation and turn to black which absorbs rays of light are unsuitable for the present invention. Examples of such a coloring agent that produces a white color include titan black, cordierite, mica, and the like.

In addition to inorganic compounds represented by a composition formula of Mg₂Al₃(AlSi₅O₁₈), analogs thereof in which a part of Mg is replaced by Fe can be used as the cordierite. Alternatively, moisture-containing cordierite can be also used.

Natural micas such as muscovite, phlogopite, biotite and sericite, and synthetic micas such as fluorphlogopite and tetrasilicic fluorine mica can be used as the mica.

The content of the coloring agent in the lower refractive index layer 23 is preferably no less than 0.0001% by mass and no greater than 2.5% by mass, and more preferably no less than 0.1% by mass and no greater than 1% by mass. When the content of the coloring agent is less than the above lower limit, sufficient color production effects may not be exerted upon the laser irradiation, and therefore a desired reflection pattern may not be formed. To the contrary, when the content of the coloring agent exceeds the above upper limit, the degree of transparency, mechanical strength and the like of the lower refractive index layer 23 may be impaired.

The light scattering portions 24 are formed into a scattered dot-like disposition pattern in a planar view (a drawing in a planar view is not shown). The disposition pattern of the light scattering portions 24 is formed so that uniform rays of light exit from the optical waveguide sheet 21 toward the front face side. Specifically, the light scattering portions 24 are formed so that a proportion of the light scattering portions 24 is low in a position adjacent to the light source and increases with an increasing distance from the light source. It is to be noted that the proportion of the light scattering portions 24 can be adjusted by changing the number of the light scattering portions 24 while keeping the size of the respective light scattering portions 24 constant, or by changing the size of the respective light scattering portions 24.

The shape of the respective light scattering portions 24 in a planar view may be linear, circular, elliptical, rectangular, or the like. In addition, the size of the respective light scattering portions 24 (in a planar view) is not particularly limited, but for example, the maximum width thereof is preferably no greater than 200 μm, and more preferably no greater than 100 μm. Furthermore, the light scattering portions 24 may have a three-dimensional shape having a height in the sheet-thickness direction. When the light scattering portions 24 have the three-dimensional shape, the shape may be semi-spherical, conular, cylindrical, polygonal pyramidal, polygonal columnar, ungual, or the like.

A laser used for irradiation of the lower refractive index layer 23 is not particularly limited, and for example, a carbon dioxide laser, a carbon monoxide laser, a semiconductor laser, a YAG (yttrium-aluminum-garnet) laser and the like may be used. Among these, a carbon dioxide laser is suitable for forming a fine dot pattern, since the carbon dioxide laser produces beams having a wavelength of 9.3 μm to 10.6 μm. A transversely excited atmospheric (TEA) type, a continuous oscillation type, and a repetitively pulsed carbon dioxide laser and the like may be used as the carbon dioxide laser.

### Production Method of Optical Waveguide Sheet 21

Next, a production method of the optical waveguide sheet 21 will be explained. However, the production method of the optical waveguide sheet 21 according to the embodiment of the present invention is not limited to the production method described below.

A production method of the optical waveguide sheet 21 includes: a first step of respectively preparing a forming material of the optical waveguide layer 22, a forming material of the lower refractive index layer 23 and a forming material of the hard coat layer 14; a second step of coextruding the forming material of the optical waveguide layer 22 and the forming material of the lower refractive index layer 23 to form the optical waveguide layer 22 and the lower refractive index layer 23 through a coextrusion molding process; and a third step of coating the forming material of the hard coat layer 14 on the back face of the lower refractive index layer 23, drying the forming material of the hard coat layer 14, and irradiating the same with an active energy ray to form the hard coat layer 14. In addition, the production method of the optical waveguide sheet 21 includes a fourth step of irradiating the lower refractive index layer 23 formed in the second step with a laser to form light scattering portions 24 in the lower refractive index layer 23.

It is to be noted that a T-die process, an inflation process and the like may be employed as the coextrusion molding process in the second step. The heating temperature for the forming material of the optical waveguide layer 22 and the forming material of the lower refractive index layer 23 in the second step is preferably no less than 150° C. and no greater than 350° C., and more preferably no less than 200° C. and no greater than 300° C. Furthermore, the method of coating the forming material of the hard coat layer 14 in the third step is similar to that for the hard coat layer 14 shown in FIG. 3.

### Advantages

The optical waveguide sheet 21 includes the lower refractive index layer 23 laminated on the back face of the optical waveguide layer 22, and therefore rays of light entering from the optical waveguide layer 22 the interface with the lower refractive index layer 23 can be totally reflected to the front face side in a suitable manner. Accordingly, the optical waveguide sheet 21 can allow rays of incident light from the light source to reliably propagate in the optical waveguide layer 22.

According to the optical waveguide sheet 21, the lower refractive index layer 23 includes the light scattering portions 24 colored through the laser irradiation, and therefore a part of the rays of light that propagate in the optical waveguide layer 22 exit from the back face of the optical waveguide layer 22 to the lower refractive index layer 23, and a part of the rays of light that exit from the back face of the optical waveguide layer 22 enter the light scattering portions 24, leading to scattering of the rays of light. Further, a part of the scattered rays of light enter again the optical waveguide layer 22 and exit from the front face of the optical waveguide sheet 21. Thus, by forming the light scattering portions 24 at desired positions in the lower refractive index layer 23 through laser irradiation, suitable rays of light can be allowed to exit from the entire front face of the optical waveguide sheet 21.

According to the optical waveguide sheet 21, since the optical waveguide layer 22 and the lower refractive index layer 23 are formed through a coextrusion molding process, the optical waveguide sheet 21 having an average thickness within the aforementioned range can be easily and surely formed.

Since the optical waveguide sheet 21 includes the optical waveguide layer 22 and the hard coat layer 14 both laminated on the lower refractive index layer 23 including the light scattering portions 24, shrinkage is less likely to occur even when laser irradiation is carried out in the vicinity of the lamination face of the lower refractive index layer 23. Thus, according to the optical waveguide sheet 21, the light scattering portions 24 can be easily and surely formed in the vicinity of the lamination face of the lower refractive index layer 23.

### Other Embodiments

It is to be noted that the optical waveguide sheet, the edge-lit backlight unit and the laptop computer according to the embodiments of the present invention may be executed in various altered or modified modes in addition to the aforementioned modes. For example, the light scattering portions are not necessarily formed in the lower refractive index layer, and may be formed in the optical waveguide layer, the hard coat layer or the interface between two laminated layers. In addition, the light scattering portions are not necessarily formed through the laser irradiation, and may be, for example, in an irregular shape formed by a hot pressing molding process. Examples of the hot pressing molding process include a method in which light scattering portions having a desired shape is formed by carrying out the hot pressing using as a die a counterpart having a shape pairing with the light scattering portions.

The optical waveguide sheet may include other layer(s) in each interlayer formed by the optical waveguide layer, the lower refractive index layer and the hard coat layer. Furthermore, the optical waveguide sheet may include on the front face side of the optical waveguide layer, a protective layer that contains, for example, an acrylic resin as a principal component. When the optical waveguide sheet includes such a protective layer, the hardness of the front face side of the optical waveguide sheet can be increased, and the scuff of the front face side can be prevented. Even when the optical waveguide sheet is configured to have a two-layer structure composed of the optical waveguide layer and the hard coat layer, the optical waveguide sheet does not necessarily include a plurality of diffusion dots on the back face of the optical waveguide layer.

The edge-lit backlight unit may include a top plate disposed on the backmost face of a liquid crystal display unit, a reflection sheet overlaid on the front face of the top plate, the optical waveguide sheet according to the embodiment of the present invention overlaid on the front face of the reflection sheet, and a light source that emits rays of light toward the end face of the optical waveguide sheet. Furthermore, when the edge-lit backlight unit has such a configuration, it is not necessary that the front face of the top plate is formed to have a reflection surface. Even in this configuration, the edge-lit backlight unit according to the embodiment of the present invention can prevent the lack in uniformity of luminance, while achieving the reduction in thickness.

### INDUSTRIAL APPLICABILITY

As explained above, according to the present invention, a reduction in thickness of laptop computers is achieved while suppressing lack in uniformity of luminance of a liquid crystal display surface of the laptop computers, and therefore the present invention can be suitably applied to, for example, ultraslim computers, Ultrabook, as generally referred to.

### EXPLANATION OF THE REFERENCE SYMBOLS

1 laptop computer, ultraslim computer
2 operation unit
3 liquid crystal display unit
4 liquid crystal panel
6 casing for a liquid crystal display unit
7 front face support member
8 hinge part
9 casing for an operation unit
11 edge-lit backlight unit, backlight unit
12 optical waveguide sheet
13 optical waveguide layer
14 hard coat layer
16 top plate
16a reflection surface
17 light source
18 diffusion dot
21 optical waveguide sheet
22 optical waveguide layer
23 lower refractive index layer
24 light scattering portion
110 edge-lit backlight unit
111 optical waveguide sheet
115 reflection sheet
116 top plate
117 light source
210 edge-lit backlight unit
211 optical waveguide sheet
216 top plate
216a reflection surface
217 light source

What is claimed is:

1. An optical waveguide sheet for use in an edge-lit backlight unit of a liquid crystal display unit in a laptop computer having a housing thickness of no greater than 21 mm, the optical waveguide sheet comprising:
an optical waveguide layer comprising a polycarbonate-based resin as a principal component; and
a hard coat layer laminated on the back face side of the optical waveguide layer,
an average thickness of the optical waveguide sheet being no greater than 600 μm.

2. The optical waveguide sheet according to claim 1, wherein an average thickness of the hard coat layer is no less than 2 μm and no greater than 20 μm.

3. The optical waveguide sheet according to claim 1, further comprising a lower refractive index layer, the lower refractive index layer being laminated on the back face of the optical waveguide layer and having a refractive index lower than that of the optical waveguide layer,
wherein the hard coat layer is laminated on the back face of the lower refractive index layer.

4. The optical waveguide sheet according to claim 3, wherein a ratio of the thickness of the lower refractive index layer to that of the optical waveguide layer is no less than 1/50 and no greater than ⅕.

5. The optical waveguide sheet according to claim 3, wherein a principal component of the lower refractive index layer is an acrylic resin.

6. The optical waveguide sheet according to claim 3, wherein a relative refractive index of the lower refractive index layer with respect to the optical waveguide layer is no greater than 0.95.

7. The optical waveguide sheet according to claim 3, wherein the lower refractive index layer comprises a light scattering portions colored through laser irradiation.

8. The optical waveguide sheet according to claim 3, wherein the optical waveguide layer and the lower refractive index layer are formed through a coextrusion molding process.

9. The optical waveguide sheet according to claim 1, wherein a pencil hardness of the back face side is at least HB.

10. An edge-lit backlight unit, comprising:
a top plate disposed on the backmost face of a liquid crystal display unit, with a front face of the top plate being formed to have a reflection surface;
the optical waveguide sheet according to claim 1, the optical waveguide sheet being overlaid on the front face of the top plate; and
a light source that emits rays of light toward the end face of the optical waveguide sheet.

11. The edge-lit backlight unit according to claim 10, wherein the top plate is made of metal, and an arithmetic average roughness (Ra) of the reflection surface is no greater than 0.2 μm.

12. An edge-lit backlight unit, comprising:
a top plate disposed on the backmost face of a liquid crystal display unit;
a reflection sheet overlaid on the front face of the top plate;
the optical waveguide sheet according to claim 1, the optical waveguide sheet being overlaid on the front face of the reflection sheet; and
a light source that emits rays of light toward the end face of the optical waveguide sheet.

13. A laptop computer, comprising the edge-lit backlight unit according to claim 10 in a liquid crystal display unit.

14. A laptop computer, comprising the edge-lit backlight unit according to claim 12 in a liquid crystal display unit.
